(19) United States
(12) Patent Application Publication
(10) Pub. No.: US 2026/0120588 A1
(43) Pub. Date: Apr. 30, 2026

(54) AN ARTIFICIAL INTELLIGENCE SYSTEM FOR MILITARY PLANNING AND DECISION SUPPORT

(71) Applicant: Andrew Sainz-Nieto, Etobicoke (CA)

(72) Inventor: Andrew Sainz-Nieto, Etobicoke (CA)

(21) Appl. No.: 18/914,051

(22) Filed: Oct. 11, 2024

(51) Int. Cl. G09B 9/00

(52) U.S. Cl. CPC G09B 9/003

(57) ABSTRACT

An artificial intelligence system for military planning and decision support is disclosed. The system comprises a central coordination agent, multiple specialized agents focused on specific military domains, and a dynamic learning module. The system analyzes inputs, activates relevant specialized agents, coordinates information exchange, and synthesizes outputs into cohesive solutions. It incorporates security and ethics verification, multi-modal interfaces, and can operate in both local and remote configurations. Advanced capabilities include multi-lingual operation, predictive maintenance, and generation of multiple courses of action with sophisticated modeling and simulation. The system is not limited to this architecture, and may instead comprise of a single AI system consolidating these functions. The system continuously learns and adapts to new scenarios while maintaining alignment with military doctrine and objectives.

### FIELD OF THE DISCLOSURE

The present invention relates to artificial intelligence systems for military planning and decision support. More specifically, the invention provides an AI-powered system that can analyze, generate, evaluate, and address plans, decisions, and queries, and provide real-time decision support to commanders and soldiers in the field.

### BACKGROUND

Military operations require complex planning and decision-making across strategic, operational, and tactical levels. While existing planning tools focus primarily on higher-level strategic and operational planning, there is a need for systems that can provide tactical-level decision support and advice to commanders and soldiers engaged in field operations. Additionally, modern military operations span multiple domains including land, air, sea, space, and cyberspace, requiring integrated planning capabilities.

The present invention addresses these needs by providing an artificial intelligence system with comprehensive knowledge across military domains that can generate tactical plans, evaluate options, and provide real-time decision support. The system incorporates knowledge of psychology, medical aid, survival skills, weapons systems, tactics, geopolitics, military history, insurgency and counterinsurgency, civil-military relations, engineering, logistics, intelligence, psychological operations, unmanned systems, military doctrine, among many others.

### BRIEF SUMMARY

The present invention relates to an artificial intelligence system for military planning and decision support, at times but not limited to being, referred to as ATHENA (Advanced Tactical Holistic Evaluator and Network-centric Advisor). ATHENA is a comprehensive AI platform that integrates extensive knowledge across multiple military domains to analyze, generate, evaluate, and address plans, decisions, and queries, providing real-time advice to commanders and soldiers.

ATHENA employs advanced machine learning algorithms, including deep neural networks, reinforcement learning techniques such as Deep Q-Networks (DQN) and Proximal Policy Optimization (PPO), and enhanced Monte Carlo Tree Search (MCTS) algorithms with neural network heuristics. The system utilizes a multi-agent architecture to rapidly generate and evaluate multiple courses of action (COAs) for any given tactical situation, considering factors such as terrain, weather, force composition, supply status, and other operational variables. Bayesian inference is used to estimate the probabilities of different outcomes and quantify risks, presenting the most promising options through an intuitive user interface.

Designed for flexibility, ATHENA can operate both locally on devices like smartphones and tablets and remotely on powerful servers. In its local configuration, a streamlined version provides immediate access to critical decision support even in environments with limited or no network connectivity. When connectivity is available, ATHENA seamlessly transitions to a client-server model, accessing the full power of remote servers for more complex tasks. Advanced data synchronization techniques ensure consistency between local and remote operations.

The system incorporates advanced natural language processing capabilities, enabling interaction through voice, text, or other data inputs across multiple languages. ATHENA can translate in real time between numerous languages, generate operational documents in multiple languages simultaneously, and provide instant translation services during multinational operations or interactions with local populations.

Security and ethical safeguards are deeply embedded in ATHENA's architecture. Robust cybersecurity measures—including end-to-end encryption, multi-factor authentication, and continuous monitoring—prevent unauthorized access or manipulation. The AI is constrained by programmed ethical guidelines based on international laws of war, military rules of engagement, and human rights principles. Explainable AI components provide justifications for recommendations, allowing human operators to understand and verify the ethical reasoning behind decisions.

ATHENA's capabilities span a wide range of military operations and domains, including but not limited to psychological operations, cyber and electronic warfare, special operations, chemical, biological, radiological, and nuclear (CBRN) operations, urban and subterranean warfare, amphibious and naval operations, air and space operations, logistics and maintenance planning, intelligence collection and analysis, counter-terrorism, and humanitarian assistance and disaster relief operations.

The system incorporates advanced modeling and simulation capabilities, leveraging physics-based models, agent-based simulations, and data-driven machine learning models to accurately represent complex military systems and their interactions. It supports training applications by generating realistic scenarios, providing automated after-action reviews, and assisting in force development by modeling and evaluating new technologies and concepts.

ATHENA is designed to integrate with existing military systems, handle conflicting or ambiguous information, and operate effectively in degraded or contested environments. Its scalable and adaptable architecture ensures consistent capabilities across different operational contexts, from strategic planning to tactical execution, enhancing operational effectiveness and contributing to improved decision-making across the full spectrum of military operations.

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 illustrates a block diagram of possible system architecture for the artificial intelligence system.

FIG. 2 illustrates a block diagram of an exemplary computer system, in which various aspects as described herein may be implemented in accordance with various embodiments disclosed herein.

FIG. 3 illustrates a block diagram of an exemplary interaction between a user, a user interface, and the AI system.

FIG. 4 illustrates a block diagram of an exemplary AI system pipeline in which various aspects as described herein may be implemented in accordance with various embodiments disclosed herein.

FIG. 5 illustrates a block diagram of an exemplary multi-agent system architecture of ATHENA, demonstrating how specialized AI agents collaborate to address complex military scenarios.

### DETAILED DESCRIPTION

The present invention relates to, inter alia, an artificial intelligence system for military planning and decision support, at times but not limited to being, referred to as ATHENA (Advanced Tactical Holistic Evaluator and Network-centric Advisor) herein. The ATHENA system incorporates comprehensive knowledge across military domains to analyze, generate, evaluate, and address plans, decisions, and queries, and provide real-time advice to commanders and soldiers.

A key strength of the ATHENA system lies in its ability to analyze, generate, evaluate, and address plans, decisions, and queries, while providing real-time advice to commanders and soldiers. The system can rapidly process vast amounts of data from multiple sources, using advanced algorithms to identify patterns, assess risks, and generate actionable insights. It can produce multiple courses of action for any given situation, evaluating each based on projected outcomes and alignment with strategic objectives. ATHENA can respond to complex queries from users, providing detailed analysis and recommendations tailored to the specific context. The system's real-time advisory capability allows it to continuously monitor the operational environment, alerting commanders to significant changes and suggesting adaptive measures.

This combination of analytical depth and real-time responsiveness enables ATHENA to provide comprehensive decision support across the full spectrum of military operations, from strategic planning to tactical execution.

ATHENA is designed with flexibility in mind, capable of operating both locally on devices such as smartphones or tablets, and remotely on powerful servers. In its local configuration, a streamlined version of ATHENA can be installed on ruggedized mobile devices, providing soldiers with immediate access to critical decision support and tactical advice, even in environments with limited or no network connectivity. This local version focuses on essential functions and leverages the device's onboard processing capabilities to deliver real-time insights. When network connectivity is available, ATHENA seamlessly transitions to a client-server model, accessing the full power of remote servers for more complex analysis and planning tasks. This hybrid approach allows for continuous operation across varied operational environments, from austere field conditions to well-connected command centers. The system employs advanced data synchronization techniques to ensure consistency between local and remote operations, enabling smooth transitions and providing users with the most up-to-date information and capabilities regardless of their operational context.

The system employs advanced reinforcement learning algorithms, such as Deep Q-Networks (DQN) and Proximal Policy Optimization (PPO), to iteratively improve its planning and decision-making capabilities. These algorithms are trained on extensive simulations of military operations, with outcomes and user feedback serving as reward signals. The system utilizes transfer learning techniques, including domain adaptation and fine-tuning of pre-trained models, to apply insights gained in one operational context to novel situations. This approach allows the system to rapidly adapt to new environments and scenarios while leveraging previously acquired knowledge.

ATHENA utilizes a multi-agent system architecture to rapidly generate and evaluate multiple courses of action (COAs) for any given tactical situation. It employs advanced Monte Carlo Tree Search (MCTS) algorithms, enhanced with neural network heuristics, to efficiently explore the decision space. The system considers a comprehensive set of factors including terrain (using digital elevation models and satellite imagery), weather (incorporating real-time meteorological data), friendly and enemy force composition (based on intelligence reports and historical data), supply status (linked to logistics databases), and numerous other variables. Each COA is simulated thousands of times using parallel processing on high-performance computing clusters, with varying parameters to account for uncertainties and potential enemy actions. The system employs Bayesian inference to estimate the probability of different outcomes and quantify risks. The most promising options are then presented to commanders through an intuitive user interface, which visualizes the projected outcomes and associated probabilities for informed decision-making.

The system's capabilities span a wide range of military operations and domains, including but not limited to: Psychological operations and information warfare, Counter-improvised explosive device (C-IED) operations, Cyber and electronic warfare, Special operations and reconnaissance missions, Chemical, biological, radiological, and nuclear (CBRN) operations, Urban and subterranean warfare, Amphibious and naval operations, Air and space operations, Logistics and maintenance planning, Intelligence collection and analysis, Counter-terrorism and counter-insurgency operations, Humanitarian assistance and disaster relief operations.

For each of these domains, ATHENA incorporates detailed modeling and simulation capabilities, allowing it to generate and evaluate highly specific tactical plans. The system utilizes a combination of physics-based models, agent-based simulations, and data-driven machine learning models to accurately represent complex military systems and their interactions. For example, in modeling urban warfare, ATHENA combines 3D city models with crowd simulation algorithms and weapons effects models to predict the outcomes of different tactical approaches. The system continuously updates its knowledge base with new tactical insights, after-action reports, and doctrinal changes, using natural language processing to extract relevant information from unstructured text data. This allows it to adapt its planning and advisory capabilities over time as warfare evolves, ensuring that its recommendations remain current and relevant.

Security and ethical safeguards are deeply embedded in the system's architecture. It incorporates robust cybersecurity protections, including end-to-end encryption, multi-factor authentication, and continuous monitoring for anomalous behavior, to prevent unauthorized access or manipulation. The AI is constrained by programmed ethical guidelines based on international laws of war, military rules of engagement, and human rights principles. These guidelines are implemented using a combination of rule-based systems and machine learning models trained on ethical decision-making scenarios. The system includes explainable AI components that can provide justifications for its recommendations, allowing human operators to understand and verify the ethical reasoning behind its decisions.

The ATHENA system's ability to provide real-time tactical advice to field units is a key capability. Using natural language processing, soldiers can query the system using voice, text, or any other data input. For example, a squad leader encountering an improvised explosive device (IED) could ask “How do I safely clear this IED?” The system would analyze details about the specific situation and provide step-by-step guidance drawing from its knowledge base and past operational data.

Psychological and cultural factors are deeply integrated into the system's planning capabilities. When developing plans for operations in populated areas, it considers local customs, tribal dynamics, religious sensitivities, and other human terrain factors. This allows for more effective civil-military operations and can help reduce civilian casualties and collateral damage.

ATHENA incorporates advanced natural language processing capabilities, enabling it to operate effectively across multiple languages. The system can translate in real-time between numerous languages, facilitating communication in multinational operations, interactions with local populations, and analysis of foreign language intelligence. This multilingual capability extends to all aspects of ATHENA's functionality, including document generation, voice interaction, and data analysis. For instance, ATHENA can generate operation orders in multiple languages simultaneously, ensuring clear communication in coalition operations. Its ability to rapidly translate and analyze foreign language communications significantly enhances intelligence gathering and processing capabilities. In interactions with local populations, ATHENA can provide instant translation services, improving the effectiveness of civil-military operations and humanitarian efforts. The system's language models are continuously updated to account for regional dialects, slang, and emerging terminology, ensuring accuracy in diverse linguistic environments. This multilingual proficiency not only enhances operational effectiveness but also contributes to improved cultural understanding and more nuanced strategic planning in global operations.

The system includes advanced modeling of weapon systems and their effects. When planning fire support, it can precisely calculate weapons effects based on factors like terrain, structures, and environmental conditions. This allows for more accurate and efficient use of supporting fires while minimizing collateral damage risks.

Logistics planning is tightly integrated with tactical planning. The system continuously monitors supply levels and projects future needs based on planned operations. It can automatically generate resupply plans and adjust tactical plans if logistical constraints are identified. The system's logistics capabilities extend to theater-wide sustainment operations, optimizing complex supply chains, planning sea and air lines of communication, and managing theater distribution networks.

For intelligence planning, the system can fuse data from multiple sources including human intelligence, signals intelligence, and open-source intelligence. It uses natural language processing and computer vision to rapidly analyze large volumes of intelligence reporting and identify key insights. The system also recommends optimal deployment of intelligence collection assets.

ATHENA incorporates detailed knowledge of adversary tactics, techniques, and procedures (TTPs). When generating friendly courses of action, it simultaneously models likely enemy responses. This allows for development of more robust plans that can adapt to enemy actions.

For joint and combined operations, the system ensures seamless integration across domains and partner forces. It can plan complex joint fires and maneuver, deconflict airspace, and synchronize effects across land, air, maritime, space, and cyberspace domains. The system also accounts for differing capabilities and doctrine when planning multinational operations.

The system's integrated approach ensures coherence between strategic goals, operational plans, and tactical execution. As changes occur at any level, ATHENA can rapidly assess impacts across echelons and recommend adjustments to maintain alignment.

For training applications, the system can generate realistic scenarios and opposing forces (OPFOR) behaviors to challenge trainees. It can dynamically adjust scenario difficulty based on trainee performance. The system can also provide automated after-action reviews, identifying areas for improvement.

While primarily designed for operational use, the system also has significant utility for force development applications. It can be used to model and evaluate new technologies, organizations, and concepts to assess their potential battlefield impact before major investments are made.

The system incorporates advanced game theory and decision theory models to analyze complex multi-actor scenarios. This is particularly useful for counterinsurgency and stability operations where multiple factions with different motivations may be present. The AI can model likely responses of various actors to different courses of action, allowing for more nuanced and effective planning.

For maritime operations, the system includes detailed hydrographic and oceanographic modeling capabilities. It can plan naval maneuvers accounting for factors like currents, tides, and underwater terrain. The AI also incorporates advanced anti-submarine warfare tactics and techniques for both offensive and defensive operations.

The system's unmanned systems capabilities extend beyond just drones to include unmanned ground and maritime vehicles. It can plan complex multi-domain unmanned operations, optimizing use of different unmanned platforms based on their unique capabilities and limitations. The AI also models potential adversary counter-unmanned system tactics.

For targeting operations, the system incorporates sophisticated collateral damage estimation models. It can rapidly assess potential civilian casualties and damage to civilian infrastructure for different weapon-target pairings. The AI recommends targeting options that achieve desired effects while minimizing collateral damage risk.

The system incorporates advanced natural language generation capabilities to produce clear, concise reports and orders. It can automatically generate operations orders, intelligence summaries, and other standard military documents based on the plans it develops. The language and format of these documents is tailored to the specific echelon and unit type.

For military operations in arctic environments, the system includes sophisticated modeling of extreme cold weather effects on personnel and equipment. It can plan operations accounting for unique arctic challenges like limited daylight, shifting ice conditions, and extended supply lines. The AI provides specific cold weather tactics and survival techniques.

The system's capabilities extend to planning for space control operations. It can model orbital mechanics to plan satellite maneuvers, optimize use of space-based assets, and develop strategies to protect friendly space capabilities. The AI also assists in planning potential offensive counterspace operations against adversary satellites.

For military police operations, the system provides comprehensive guidance on various aspects including detention operations, civil disturbance management, and evidence collection. It incorporates international law and military regulations, emphasizing proper procedures for prisoner handling, facility management, and prevention of detainee abuse. The AI can model crowd dynamics and assist in planning crowd control tactics that maintain order while respecting civil liberties. It also incorporates de-escalation techniques and emphasizes minimizing use of force when possible.

The system's capabilities for counter-terrorism and counter-insurgency operations are extensive. It can rapidly analyze vast amounts of intelligence data to identify potential threats and generate actionable intelligence. The AI uses pattern recognition and anomaly detection algorithms to flag suspicious activities or individuals for further investigation. It can model terrorist and insurgent network structures to identify key nodes for targeting or disruption. The system also assists in planning population-centric operations to isolate insurgents from their base of support.

For military information support operations (MISO) and psychological operations (PSYOP), the system can develop sophisticated influence campaigns tailored to specific target audiences. It analyzes factors like cultural values, information consumption patterns, and existing narratives to craft effective messaging. The AI models potential cognitive and behavioral effects of these campaigns, allowing for more precise and effective influence operations. It can also plan dissemination through multiple channels and model potential second and third-order effects of information operations.

The system incorporates advanced capabilities for planning and executing cyber operations. It can model complex network topologies, simulate effects of various cyber tools and techniques, and develop coordinated cyber-kinetic operations. The AI assists in developing defensive cyber strategies and in planning potential offensive cyber operations against adversary networks. It also models potential cascading effects of cyber actions across interconnected systems.

For electronic warfare (EW) operations, the system includes sophisticated modeling of the electromagnetic environment. It can plan optimal employment of EW assets for both offensive and defensive operations. The AI assists in managing the electromagnetic spectrum, deconflicting friendly EW activities and communications while maximizing disruption of enemy systems. It can precisely calculate jamming effectiveness based on factors like terrain, atmospheric conditions, and target system characteristics.

The system's capabilities for chemical, biological, radiological, and nuclear (CBRN) operations are comprehensive. It includes detailed modeling of CBRN agent dispersion and effects, can rapidly generate contamination predictions, recommend optimal protective measures, and plan decontamination operations. The AI can plan specialized CBRN reconnaissance, develop contamination avoidance routes, and recommend appropriate protective postures. It also supports CBRN consequence management planning and provides guidance on WMD decontamination procedures.

For special operations and reconnaissance missions, the system can generate detailed infiltration and exfiltration plans optimized for stealth and survivability. It accounts for factors like enemy detection capabilities, indigenous support networks, and environmental conditions.

The AI provides specific guidance on topics like cache management, evasion techniques, and survival skills tailored to the operational environment. It can also plan for unconventional warfare, foreign internal defense, and direct-action missions, considering factors such as indigenous support networks, host nation capabilities, and geopolitical sensitivities.

The system's intelligence capabilities span multiple disciplines. For geospatial intelligence (GEOINT), it can rapidly process and fuse data from multiple sources including satellite imagery, aerial photography, and terrain databases. For signals intelligence (SIGINT), it incorporates advanced natural language processing to analyze large volumes of intercepted communications. For measurement and signature intelligence (MASINT), it assists in planning optimal sensor placement and interpreting complex signature data. The system also excels in open-source intelligence (OSINT) collection and analysis, rapidly processing vast amounts of publicly available information from sources like social media, news outlets, and academic publications.

For amphibious operations, the system incorporates detailed hydrographic and beach condition modeling. It can plan ship-to-shore movement accounting for factors like tides, surf conditions, and beach gradients. The AI optimizes selection of landing sites and assists in coordinating complex amphibious assaults involving multiple landing forces and supporting elements. It also integrates this with broader maritime operation planning, including naval maneuvers and anti-submarine warfare tactics.

The system's capabilities for urban operations are extensive. It incorporates detailed 3D mapping and modeling of complex urban terrain, including subterranean networks. It can plan operations accounting for factors like inter-visibility, fields of fire, and civilian population densities. The AI provides specific tactics for different urban environments, from dense city centers to sprawling slums, and can adapt these for megacity environments with their unique challenges, including considerations for subterranean operations.

For military engineering operations, the system can rapidly develop plans for constructing or repairing infrastructure in austere environments. It optimizes use of available materials, equipment, and personnel to meet operational timelines. The AI also incorporates force protection considerations into all engineering plans, assisting in planning defensive fortifications and obstacle emplacement.

The system includes advanced modeling of electromagnetic pulse (EMP) effects for both offensive and defensive planning. It can simulate the impacts of EMP on various electronic systems and infrastructure. The AI assists in developing hardening strategies to protect friendly systems from EMP effects and in planning potential offensive use of EMP weapons.

For non-combatant evacuation operations (NEO), the system can rapidly develop evacuation plans accounting for factors like local transportation infrastructure, potential hostile threats, and evacuee demographics. It provides specific guidance on topics like evacuation messaging, assembly point operations, and reception procedures.

The system's medical planning capabilities include detailed modeling of casualty flows and treatment requirements. It can optimize placement of medical assets and plan casualty evacuation routes. The AI also incorporates triage protocols to maximize life-saving interventions when resources are constrained.

For military support to civil authorities in domestic emergency scenarios, the system can rapidly develop plans for situations like natural disaster response, pandemic management, or civil unrest. It ensures proper integration of military capabilities with civilian agencies while adhering to legal restrictions on domestic military operations. This extends to planning for military support to humanitarian assistance and disaster relief operations internationally, where it can rapidly assess damage, model population movements, and optimize distribution of aid.

The system incorporates extensive knowledge of international law and rules of engagement, utilizing a comprehensive legal database that is regularly updated with the latest treaties, conventions, and military regulations. When developing plans, it automatically checks for compliance with applicable laws and policies using a sophisticated rule-based system combined with natural language processing algorithms. These algorithms can interpret complex legal texts and apply them to specific operational contexts. The AI can provide commanders with a detailed analysis of the legal implications of different courses of action, including potential risks of violating international law or rules of engagement. This analysis includes confidence levels for its legal assessments, highlighting areas of legal uncertainty that may require human expert consultation. The system also maintains a detailed audit trail of its decision-making process, allowing for post-operation review of legal compliance. This ensures that operations are conducted within legal and ethical boundaries, reducing the risk of unintended violations and supporting accountability in military operations.

For counter-drone operations, the system continuously analyzes patterns in adversary drone usage to identify trends and vulnerabilities. It can recommend optimal placement of counter-drone systems and advise on electronic warfare tactics to disrupt enemy drone operations. The AI also assists in developing friendly drone tactics to overcome adversary counter-measures.

The system's capabilities for military deception operations are sophisticated. It can develop complex, multi-layered deception plans that integrate physical, electronic, and informational elements. The AI models adversary intelligence collection capabilities and cognitive biases to craft deceptions most likely to achieve the desired effect on enemy decision-making. It ensures deception plans are consistent across all domains and lines of operation.

The system incorporates advanced predictive maintenance capabilities for military equipment. Using sophisticated AI algorithms, including deep learning models and time series analysis, it analyzes sensor data, maintenance records, and operational history to forecast potential failures before they occur. The system employs Internet of Things (IOT) sensors to collect real-time data on equipment performance, including vibration patterns, temperature fluctuations, and other key indicators of mechanical health. This data is processed using edge computing devices for immediate analysis, with more complex computations performed in secure cloud environments. The AI models are continuously updated using federated learning techniques, allowing for improved predictions without compromising data security. This predictive approach allows for more efficient scheduling of maintenance activities, reduces unexpected equipment downtime during operations, and optimizes the allocation of maintenance resources. The system can also recommend optimal maintenance procedures based on the specific condition of each piece of equipment, potentially extending operational lifespans and reducing overall maintenance costs.

For military diplomacy and security cooperation activities, the system can analyze geopolitical factors, historical relationships, and current strategic objectives to recommend optimal engagement strategies with partner nations. The AI provides cultural awareness training and advises on effective communication strategies for military-to-military engagements.

The system's capabilities extend to planning for military support to border security operations. It can optimize placement of surveillance assets, model potential infiltration routes, and develop response plans for various border incursion scenarios. The AI ensures proper integration of military capabilities with civilian law enforcement agencies in border security contexts.

For counter-sniper operations, the system includes sophisticated acoustic modeling and shot detection algorithms. It can rapidly triangulate sniper positions based on sensor data and recommend optimal counter-sniper tactics. The AI also assists in planning preventive measures like identifying and securing potential sniper positions in an area of operations.

The system incorporates detailed modeling of subterranean environments. It can plan operations in tunnel complexes or underground facilities, accounting for unique challenges in areas like communication, navigation, and air quality. The AI provides specific tactics and techniques optimized for subterranean warfare.

For non-lethal weapons employment, the system incorporates detailed modeling of various non-lethal technologies and their effects. It can plan optimal use of non-lethal weapons to achieve desired effects while minimizing risk of unintended injuries. The AI provides guidance on appropriate escalation of force procedures integrating non-lethal and lethal options.

The ATHENA system's capabilities extend significantly to aircraft operations and air warfare. For fixed-wing aircraft, the system can optimize mission planning, considering factors such as fuel efficiency, payload capacity, and threat avoidance. It assists in developing complex air tasking orders (ATOs), balancing the allocation of air assets across various mission types including air superiority, close air support, and strategic bombing. For rotary-wing aircraft, ATHENA provides detailed mission planning for operations such as air assault, medical evacuation, and reconnaissance. The system incorporates advanced modeling of aircraft performance characteristics, weapons systems, and avionics capabilities. It can simulate air-to-air and air-to-ground engagements, allowing for the evaluation of different tactics and weapon employment strategies. ATHENA also integrates air operations with other domains, ensuring seamless coordination between air and ground forces, and optimizing the use of airspace in joint operations.

The system's capabilities for nuclear operations include detailed modeling of nuclear weapons effects and can assist in developing nuclear posture and deterrence strategies. It utilizes advanced physics-based simulations to model the effects of nuclear detonations, including blast, thermal radiation, and electromagnetic pulse (EMP) impacts. The AI strictly adheres to established protocols and safeguards for nuclear operations planning, incorporating multiple layers of verification and authentication to prevent unauthorized access or execution of nuclear-related plans. The system can model complex scenarios involving multiple nuclear actors, assessing the potential for escalation and the effectiveness of different deterrence strategies. It employs game theory algorithms to analyze strategic interactions between nuclear powers and evaluate the stability of different nuclear postures. The AI can also model potential adversary nuclear doctrine and capabilities, using a combination of open-source intelligence analysis and classified data inputs to inform friendly planning. This includes assessing the impact of emerging technologies, such as hypersonic weapons or advanced early warning systems, on nuclear deterrence dynamics. The system is programmed to prioritize de-escalation and conflict prevention in its nuclear strategy recommendations, aligning with international efforts to reduce nuclear risks.

While the system is designed primarily for military applications, its capabilities could potentially be adapted for civilian emergency management and disaster response operations. The AI's ability to rapidly develop and evaluate complex plans could aid in coordinating large-scale relief efforts.

The ATHENA system incorporates advanced capabilities for handling conflicting or ambiguous information, operating in degraded or contested environments, and integrating with existing military systems. For managing conflicting or ambiguous data, ATHENA employs Bayesian belief networks to reason about uncertainties, fuzzy logic principles for handling imprecise information, and sophisticated multi-source fusion algorithms to integrate data from various sources. The system utilizes a hierarchical conflict resolution strategy, cross-referencing with historical data and checking source reliability. All outputs include quantified measures of uncertainty, enabling operators to understand the confidence level of analyses and recommendations. In degraded or contested environments, such as those encountered in electronic warfare scenarios or situations with limited connectivity, ATHENA maintains operational effectiveness through a distributed, mesh-network architecture that can function even if some nodes are compromised. The system employs graceful degradation, prioritizing critical functions as network quality diminishes, and incorporates significant local processing capability in each node for continued operation when disconnected. ATHENA's communication systems feature advanced anti-jamming protocols, including frequency hopping and spread spectrum techniques, while its hardware is designed to withstand electromagnetic pulse attacks. A robust offline mode allows for independent operation over extended periods, with synchronization occurring when connectivity is restored. Integration with existing military command and control systems and databases is facilitated through support for a wide range of military-standard interfaces and protocols, including Link 16, JREAP, and SADL. ATHENA includes adapters for interfacing with legacy systems, employs real-time data synchronization to maintain consistency with external databases, and provides a robust API framework for easy integration of new capabilities. The system incorporates multi-level security features to properly handle information at different classification levels, and utilizes sophisticated data transformation capabilities to convert between various military data formats. Advanced compression and prioritization algorithms optimize data transfer in bandwidth-constrained environments, while the system's modular design allows for rapid adaptation to new or changing military systems. ATHENA can also interface with existing military simulation and training systems, and incorporates certified cross-domain solutions for secure data transfer between networks of different security classifications.

The ATHENA system's capabilities extend beyond basic integration and data handling to provide advanced decision support and operational enhancement. The system employs a multi-modal interface capable of processing and generating various data types, including text, audio, video, and structured data inputs. For audio processing, ATHENA utilizes state-of-the-art speech recognition and natural language understanding models to interpret voice commands and generate spoken responses. Image and video analysis is accomplished through advanced computer vision algorithms, enabling the extraction of relevant information from visual inputs and the generation of visual outputs such as annotated maps or simulated scenarios. The system's document processing capabilities leverage natural language processing and optical character recognition to extract information from various document formats and generate formatted military documents, including operations orders and intelligence summaries.

ATHENA's sensor data integration capabilities allow it to process and interpret data from a wide array of military sensors, including radar, sonar, and electronic intelligence systems. This information is seamlessly integrated into the system's analysis and decision-making processes, providing a comprehensive operational picture. Furthermore, the system is capable of generating outputs suitable for augmented reality displays, offering real-time, context-aware information overlays for field operations. This feature enhances situational awareness and facilitates more intuitive interaction with complex data sets in dynamic operational environments.

The system incorporates advanced predictive maintenance capabilities for military equipment. Utilizing sophisticated AI algorithms, including deep learning models and time series analysis, ATHENA analyzes sensor data, maintenance records, and operational history to forecast potential equipment failures before they occur. The system employs Internet of Things (IOT) sensors to collect real-time data on equipment performance, including vibration patterns, temperature fluctuations, and other key indicators of mechanical health. This data is processed using edge computing devices for immediate analysis, with more complex computations performed in secure cloud environments. The AI models, with exception of some local models, are continuously updated using federated learning techniques, allowing for improved predictions without compromising data security.

ATHENA's architecture is designed for scalability and adaptability. The system can operate on a variety of hardware platforms, from high-performance computing clusters in command centers to ruggedized, portable devices in the field. This flexibility allows ATHENA to provide consistent capabilities across different operational contexts, from strategic planning to tactical execution. The system employs dynamic resource allocation, automatically adjusting its processing distribution based on available hardware resources and the criticality of tasks. This ensures optimal performance across a wide range of deployment scenarios, from large-scale operations to small unit tactics.

Security is a paramount concern in ATHENA's design. The system incorporates multiple layers of cybersecurity protections, including advanced encryption for data at rest and in transit, continuous monitoring for anomalous behavior, and robust authentication mechanisms.

ATHENA also includes features for data compartmentalization, allowing it to handle information of varying classification levels within the same system while maintaining strict access controls. In the event of a security breach, the system can rapidly isolate affected components to prevent wider compromise, ensuring continuity of critical functions.

ATHENA incorporates an advanced explainable AI (XAI) module, which provides transparency into its decision-making processes. This feature allows users to understand the reasoning behind the system's recommendations and analyses, crucial for building trust and ensuring accountability in military operations. The XAI module utilizes techniques such as LIME (Local Interpretable Model-agnostic Explanations) and SHAP (SHapley Additive explanations) to provide intuitive, human-readable explanations for complex AI-driven decisions. These explanations can be tailored to different levels of technical expertise, ensuring that both AI specialists and field operators can understand and validate the system's outputs.

The system features a sophisticated simulation engine that allows for rapid scenario modeling and wargaming. This engine can generate thousands of potential outcomes for a given course of action, taking into account variables such as terrain, weather, force composition, and enemy capabilities. The simulation results are used to inform ATHENA's recommendations and can also be presented to human decision-makers for further analysis. The simulation engine is continuously updated with real-world data and after-action reports, ensuring that its models remain accurate and relevant.

ATHENA includes an advanced natural language generation (NLG) module that can produce human-readable reports, briefings, and orders in multiple languages. This module uses context-aware language models to generate text that adheres to military writing conventions and terminology. The NLG capability allows ATHENA to automatically produce detailed operation orders, intelligence summaries, and after-action reports, significantly reducing the time required for documentation and improving the consistency and completeness of military communications.

The system incorporates a continuous learning module that allows it to improve its performance over time based on operational feedback and outcomes. This module employs reinforcement learning techniques to refine its decision-making processes and update its knowledge base. It can identify patterns and insights from past operations that might not be immediately apparent to human analysts, potentially uncovering new tactical or strategic approaches. The continuous learning module includes safeguards to prevent the incorporation of biased or erroneous data, ensuring that the system's evolution remains aligned with established military doctrine and ethical guidelines.

ATHENA features a sophisticated multi-agent architecture that allows it to model and simulate complex, multi-actor scenarios. This is particularly useful for analyzing asymmetric warfare, counterinsurgency operations, and complex geopolitical situations. The multi-agent system can model the behaviors and interactions of various actors, including friendly forces, enemy combatants, civilian populations, and non-governmental organizations. This capability enables ATHENA to provide nuanced analyses of complex operational environments and to generate strategies that account for the diverse motivations and behaviors of multiple stakeholders.

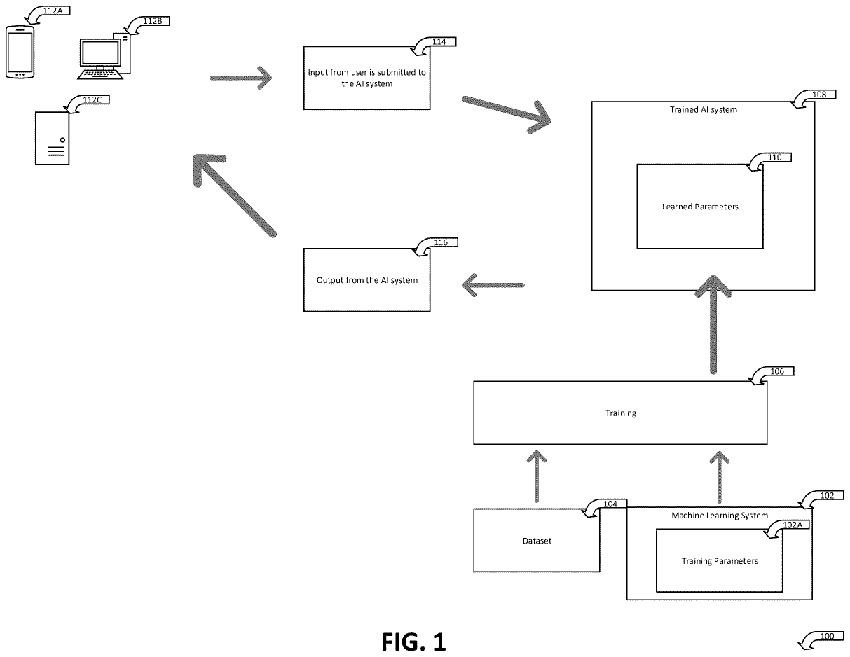

FIG. 1 illustrates an example system architecture 100. As shown in FIG. 1, the AI system may comprise an AI system 102 with a set of training parameters 102A. The AI System 102 may consist of combining deep neural networks for pattern recognition and decision-making with symbolic AI for reasoning and knowledge representation. The system learns values of the parameters 102A during a training stage 106 based on a diverse dataset 104, which includes historical military operations data, simulated scenarios, and expert knowledge bases. The training process utilizes advanced techniques such as transfer learning and meta-learning to efficiently adapt to new domains. After the training stage 106, a trained AI system 108 is obtained, configured with learned parameter values 110. These learned parameters include weights and biases of neural networks, decision tree structures, and other model-specific parameters. The trained AI system 108 is utilized by the user 114 by interfacing with various devices 112A-C, which may include ruggedized military tablets, command center workstations, or mobile devices. The AI system 116 receives the request in form of data 114, which could include text inputs, voice commands, or sensor data. It then processes this input using its trained models and knowledge bases, and outputs its response 116, which may include tactical recommendations, situation analyses, or answers to specific queries.

In some embodiments, the AI system 102 may include a sophisticated neural network architecture with multiple specialized components. The core of the system may be based on a large language model, similar to GPT architectures, that has been fine-tuned on military domain knowledge. This is augmented with task-specific modules for various military functions. For example, the tactical planning module might use graph neural networks to reason about spatial relationships and unit movements. The intelligence analysis module could employ transformer-based models for processing and correlating diverse intelligence inputs. Reinforcement learning models may be used for strategy optimization and wargaming simulations. The parameters 102A of these neural networks include not just weights and biases, but also attention mechanisms, layer connectivity patterns, and hyperparameters governing the behavior of each component. The final output layer of the neural network may use a mixture of experts approach, dynamically routing queries to the most relevant specialized sub-networks based on the task at hand.

In some embodiments, the training parameters 102A are optimized using a multi-stage training process. Initial pre-training may be done on a large corpus of general military texts and historical data to build a broad knowledge base. This is followed by supervised fine-tuning on specific military tasks using carefully curated datasets. The number of epochs for each dataset is determined dynamically using early stopping techniques to prevent overfitting. The learning rate is managed using adaptive optimization algorithms like Adam or AdamW, with learning rate schedules that warm up and then decay over time. The text encoder may use a separate learning rate to allow for more stable fine-tuning of pre-trained language models. Advanced regularization techniques such as dropout, layer normalization, and gradient clipping are employed to improve generalization. The dataset 104 is prepared using a combination of expert-curated data, synthetic data generation, and data augmentation techniques. This includes creating adversarial examples to improve robustness and using techniques like back-translation for text data augmentation. The dataset may include multi-modal inputs, combining text, audio, video, and structured data to train a more versatile system. In some embodiments, a dataset 104 may include one or more question and answer pairs. These may include a system prompt. In some embodiments, the dataset 104 may use, but is not limited to, one of many alternative formats, such as an instruction-input-output format.

After the AI system is trained during the training stage 106, a trained AI system 108 is obtained. The trained AI system 108 may have learned parameters 112A that optimize the AI system 108 ability to analyze, generate, evaluate, and address plans, decisions, and queries, or a combination thereof based on the dataset 104. These learned parameters 110 include not only the weights and biases of neural networks but also more complex structures such as attention matrices, memory banks for long-term information storage, and meta-learning parameters that allow the system to quickly adapt to new scenarios. The learned parameters 110 may also include symbolic knowledge representations, such as decision trees or logic rules, that complement the neural components. Some parameters of the learned parameters 110 may be determined through gradient-based optimization during the training stage 106, while others may be determined by evolutionary algorithms or Bayesian optimization techniques. The system also maintains a set of uncertainty estimates for its parameters, allowing it to quantify confidence in its outputs and identify areas where additional training or human expertise may be needed.

In some embodiments, the AI system 108 outputs an analysis, generation, evaluation, and addresses plans, decisions, and queries 116 based on input received 114 from one or more devices 112A-C. For example, the device(s) may include a smart phone 112A, a computing system 112B, or a device connected to a server 112C. Some embodiments are not limited to data from the devices described herein, as the AI system 108 may receive data 114 from different devices.

After responding to the received input(s) 114, the AI system 108 outputs its analysis, generation, evaluation, or response 116. In some embodiments, the output 116 may be sent to a device from which the input data 114 was received. For example, the its analysis, generation, evaluation, or response 116 may be output to mobile device 112A from which the input data 114 was received. The mobile device 112A may display or render audio of the output 116 in a display or speakers of the device 112A, and store the data on the device itself 112A. In some embodiments, if configured as such, a remote device hosting the AI system 108 may be configured to store the analysis, generation, or evaluation 116. In some embodiments, the AI system 108 may be configured to use the analysis, generation, evaluation, or response 116 for subsequent evaluation of performance of the AI system 108 and/or retraining of the AI system 108, or expanding the dataset 104. In some embodiments, the AI system 108 may be deployed locally on a device from which the input(s) 114 were received. For example, the AI system 108 may be part of a secure, containerized application installed on the mobile device 112A that, when executed by the mobile device 112A, performs the analysis, generation, evaluation, or response of plans, decisions, and queries based on the received data 114. This local deployment utilizes edge computing techniques to ensure functionality in environments with limited or no network connectivity. The local version may use quantized or pruned models to reduce computational requirements while maintaining acceptable performance. It may also employ federated learning techniques to improve its models over time without compromising data security by sending only model updates, not raw data, to central servers when connectivity is available.

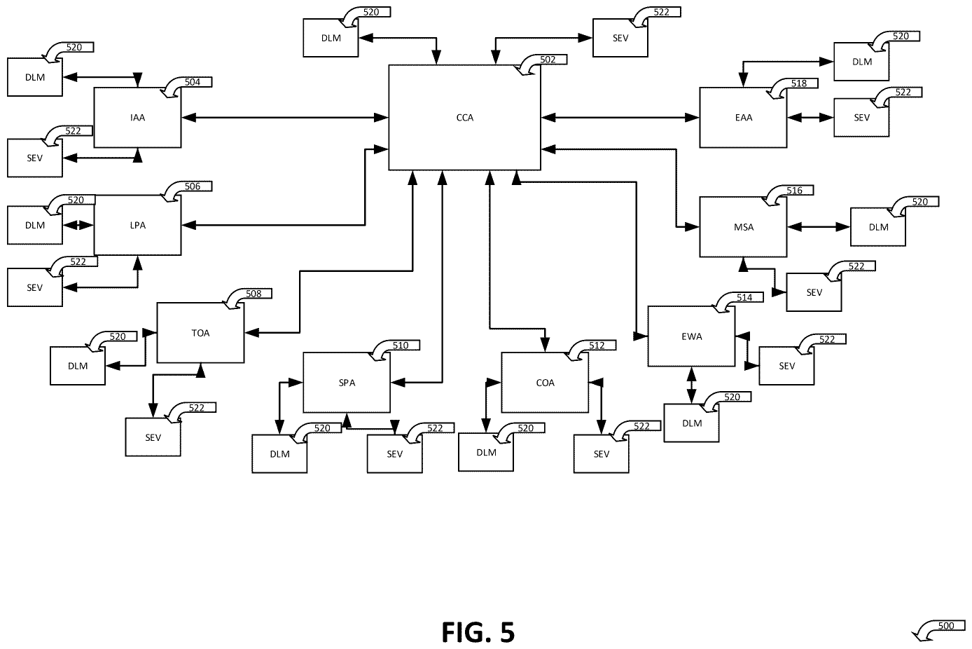

In an alternative embodiment, as illustrated in FIG. 5, the AI System 102 may be implemented as a multi-agent architecture rather than a single AI engine. In this configuration, the AI System 102 comprises multiple specialized AI agents, each focusing on specific domains such as intelligence analysis, logistics planning, tactical operations, and others. These agents are coordinated by a Central Coordination Agent (CCA) that manages task allocation, information flow, and integration of outputs from various specialized agents. This multi-agent approach allows for more nuanced and comprehensive analysis, leveraging domain-specific expertise while maintaining a holistic view of military operations. The training process 106 in this embodiment involves not only training individual specialized agents but also optimizing their collaborative interactions and the coordination mechanisms of the CCA. The resulting trained AI system 108 in this case represents a sophisticated network of interoperating AI agents, each contributing its specific expertise to the overall military planning and decision support capabilities of ATHENA.

In some embodiments, the AI system 108 may be deployed locally on a device from which the input(s) 114 were received. For example, the AI system 108 may be part of an application installed on the mobile device 112A that, when executed by the mobile device 112A, performs the analysis, generation, evaluation, or response of plans, decisions, and queries based on the received data 114. In some embodiments, the AI system 108 may be implemented on one or more separate computers. The AI system 108 may receive the text, audio, video, or image 114 via a communication interface. The communication interface may be a wireless network connection, or a wired connection. For example, the AI system 108 may be implemented on a server. The server may receive the input(s) 114 via a network (e.g., via the Internet). In another example, the AI system 108 may be a desktop computer which receives the input(s) 114 via a wired connection (e.g., USB) from one or more of the devices 112A-C. Some embodiments are not limited by how the AI system 108 obtains the input(s) 114.

In some embodiments, a device (e.g., the one or more devices 112A-C) may be communicatively coupled to a server (e.g., the AI system 108). In these embodiments, the AI system 108 may receive, via a server processor (e.g., a processor (not shown) of the AI system 108) or a device processor (e.g., a processor (not shown) of the one or more devices 112A-C), at least one text, audio, video, or image from the device.

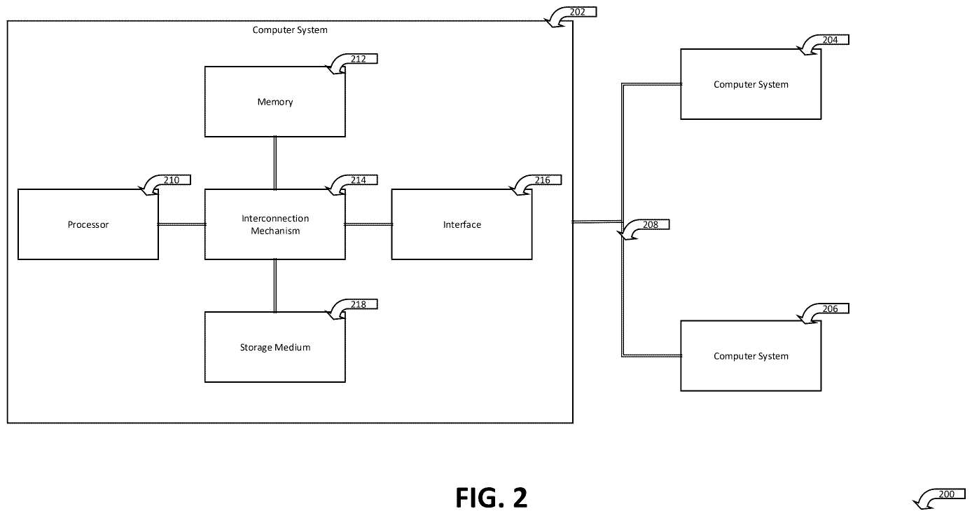

FIG. 2 illustrates a block diagram of a specially configured distributed computer system 200, in which various aspects may be implemented. As shown, the distributed computer system 200 includes one or more computer systems that exchange information. More specifically, the distributed computer system 200 includes computer systems 202, 204, and 206. As shown, the computer systems 202, 204, and 206 are interconnected by, and may exchange data through, a communication network 208. The network 208 may include any communication network through which computer systems may exchange data. To exchange data using the network 208, the computer systems 202, 204, and 206 and the network 208 may use various methods, protocols and standards, including, among others, Fiber Channel, Token Ring, Ethernet, Wireless Ethernet, Bluetooth, IP, IPV6, TCP/IP, UDP, DTN, HTTP, FTP, SNMP, SMS, MIMS, SS6, JSON, SOAP, CORBA, REST, and Web Services. To ensure data transfer is secure, the computer systems 202, 204, and 206 may transmit data via the network 208 using a variety of security measures including, for example, SSL or VPN technologies. While the distributed computer system 200 illustrates three networked computer systems, the distributed computer system 200 is not so limited and may include any number of computer systems and computing devices, networked using any medium and communication protocol.

As illustrated in FIG. 2, the computer system 202 includes a processor 210, a memory 212, an interconnection element 214, an interface 216 and data storage element 218. To implement at least some of the aspects, functions, and processes disclosed herein, the processor 210 may perform a series of instructions that result in manipulated data. The processor 210 may be any type of processor, multiprocessor, graphics processor, tensor processor, digital signal processor, or controller. Example processors may include a commercially available processor such as an Intel Xeon, Itanium, Core, Celeron, or Pentium processor; an AMD Opteron processor; an Apple A10 or A5 processor; a Sun UltraSPARC processor; an IBM Power5+ processor; an IBM mainframe chip; or a quantum computer. The processor 210 is connected to other system components, including one or more memory devices 212, by the interconnection element 214.

The memory 212 stores programs (e.g., sequences of instructions coded to be executable by the processor 210) and data during operation of the computer system 202. Thus, the memory 212 may be a relatively high performance, volatile, random access memory such as a dynamic random access memory (“DRAM”) or static memory (“SRAM”). However, the memory 212 may include any device for storing data, such as a disk drive or other nonvolatile storage device. Various examples may organize the memory 212 into particularized and, in some cases, unique structures to perform the functions disclosed herein. These data structures may be sized and organized to store values for particular data and types of data.

Components of the computer system 202 are coupled by an interconnection element such as the interconnection mechanism 214. The interconnection element 214 may include any communication coupling between system components such as one or more physical busses in conformance with specialized or standard computing bus technologies such as IDE, SCSI, PCI and InfiniBand. The interconnection element 214 enables communications, including instructions and data, to be exchanged between system components of the computer system 202.

The computer system 202 also includes one or more interface devices 216 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 202 to exchange information and to communicate with external entities, such as users and other systems.

The data storage element 218 includes a computer readable and writeable nonvolatile, or non-transitory, data storage medium in which instructions are stored that define a program or other object that is executed by the processor 210. The data storage element 218 also may include information that is recorded, on or in, the medium, and that is processed by the processor 210 during execution of the program. More specifically, the information may be stored in one or more data structures specifically configured to conserve storage space or increase data exchange performance. The instructions may be persistently stored as encoded signals, and the instructions may cause the processor 210 to perform any of the functions described herein. The medium may, for example, be optical disk, magnetic disk or flash memory, among others. In operation, the processor 210 or some other controller causes data to be read from the nonvolatile recording medium into another memory, such as the memory 212, that allows for faster access to the information by the processor 210 than does the storage medium included in the data storage element 218. The memory may be located in the data storage element 218 or in the memory 212, however, the processor 210 manipulates the data within the memory, and then copies the data to the storage medium associated with the data storage element 218 after processing is completed. A variety of components may manage data movement between the storage medium and other memory elements and examples are not limited to particular data management components. Further, examples are not limited to a particular memory system or data storage system.

Although the computer system 202 is shown by way of example as one type of computer system upon which various aspects and functions may be practiced, aspects and functions are not limited to being implemented on the computer system 202 as shown in FIG. 2. Various aspects and functions may be practiced on one or more computers having a different architectures or components than that shown in FIG. 2. For instance, the computer system 202 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 202 may be a computer system including an operating system that manages at least a portion of the hardware elements included in the computer system 202. In some examples, a processor or controller, such as the processor 210, executes an operating system. Examples of a particular operating system that may be executed include a Windows based operating system, such as, Windows NT, Windows 2000 (Windows ME), Windows XP, Windows Vista or Windows 8, 10, or 11 operating systems, available from the Microsoft Corporation, a MAC OS System X operating system or an iOS operating system available from Apple Computer, one of many Linux-based operating system distributions, for example, the Enterprise Linux operating system available from Red Hat Inc., a Solaris operating system available from Oracle Corporation, or a UNIX operating systems available from various sources. Many other operating systems may be used, and examples are not limited to any particular operating system.

The processor 210 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as. Net, SmallTalk, Java, C++, Ada, C #( C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user space application) or in a commonly shared data structure (such as an application registry that is defined by an operating system). In addition, some examples provide for both system and user interfaces that allow external entities to modify the parameters and thereby configure the behavior of the components.

Based on the foregoing disclosure, it should be apparent to one of ordinary skill in the art that the embodiments disclosed herein are not limited to a particular computer system platform, processor, operating system, network, or communication protocol. Also, it should be apparent that the embodiments disclosed herein are not limited to a specific architecture.

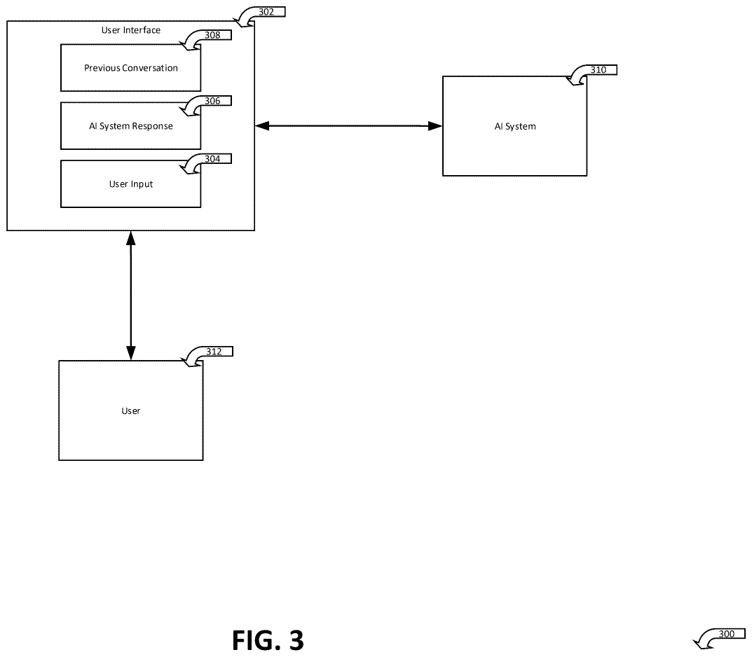

FIG. 3 illustrates an exemplary interaction between a user 312, an AI system 310, and the user interface 302 that facilitates it. The user interface 302 may consist of 3 parts; the user input (e.g., one or more text, audio, video, or image) 304, the AI system 310 displayed output (e.g., one or more text, audio, video, or image) 306, and the prior conversation (e.g., between the user 304 and AI system 310) 308. This user interface 302 is in contact with the AI system 310, either locally or remotely, and provides a medium in which it may interact with the user 312. For example, the user 312 decides to input 304 the text “What is the length of the M16 rifle?”. This data is then passed on to the AI system 310 where it analyzes, generates, evaluates, and addresses plans, decisions, and queries. After doing so, it returns its response “38.81in” to the user interface 302 which then displays the AI system response 306. With each new input the user interface 302 receives, may it be from the user 304 or the AI system 306, all prior inputs and responses are pushed into previous conversation 308 for later reference. In some embodiments, previous conversations 308 are not displayed in the user interface 302, instead displaying the most recent user input 304 and AI system response 306. The interface 302 may include robust authentication mechanisms to ensure only authorized personnel can access the system. It may also feature customizable layouts to accommodate different operational roles and preferences.

In some embodiments, the user interface 302 may not be visual but instead take any other medium that facilities an interaction between the user 312 and the AI system 310, such as by auditory or electrical stimulation. For example, the AI system 310 may communicate via audio messages to the user 312, with the user interface 302 instead taking the form of backend code. This could be particularly useful in hands-free scenarios like vehicle operations or during physical activities. The system might also integrate with tactile feedback devices for silent communication in covert operations. In some embodiments, the prior conversation 308 may not be included, with the user interface 302 instead facilitating live communication between the user 312 and the AI system 310. This stateless mode of operation could be useful in high-security environments where maintaining conversation history might pose a risk.

In some embodiments, there may be more than one user 312 connected to the user interface 302. This would enable multiple users to interact with the AI system 310 simultaneously, facilitating collaborative planning and decision-making. The system employs advanced role-based access control to ensure users only access information and capabilities appropriate to their clearance level and operational role. In some embodiments, there may be more than one AI system 310 connected to the user interface 302. Such a setup may enable heavy workloads to be distributed between multiple AI systems, improving response times and system resilience. This distributed architecture could also allow for specialized AI systems to handle specific domains (e.g., one for logistics, another for intelligence analysis) while presenting a unified interface to the user. In some embodiments, there may be multiple user interfaces. This would allow easier organization of different conversation topics or operational threads, for example. The system maintains consistency across these interfaces through a centralized state management system. In some embodiments, there may be a combination of these architectures, creating a flexible, scalable system that can adapt to various operational needs and organizational structures.

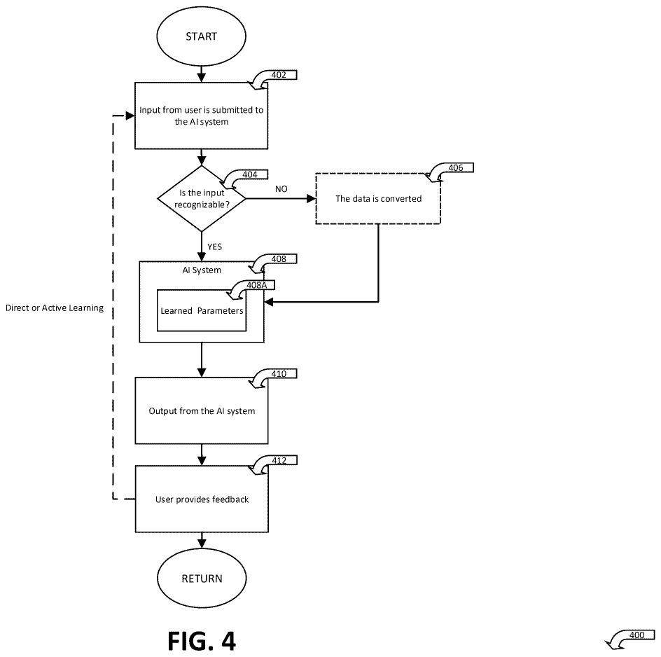

FIG. 4 illustrates an exemplary AI system pipeline 400 in which various aspects as described herein may be implemented in accordance with various embodiments disclosed herein. The pipeline begins with user input 402, which can be in various formats including text, voice, images, or structured data. A preprocessing module, which may include both rule-based systems and machine learning models, determines if the input type is recognizable 404 to the AI. This module employs techniques such as format detection, metadata analysis, and content-based classification. Some inputs, such as video, may need to be broken into separate images, or converted to text to be readily recognizable to the AI system 408. For example, a video recording of a BMP-2 driving across a road may not be identifiable to the AI system 408. Should this be the case, the data may be converted 406 either by a script, a different AI system, or some other method, to an alternative medium. Continuing the example, this method could be a script that separates the videos by frames, into images, where it is then given to an AI vision system (not shown). This vision system would then describe into text format that the video displays a BMP-2 driving across a road. This text would then be pass on to the AI system 408. If the input 402 however is determined to be recognizable 404 by whichever method used, then it may go directly to the AI system 408 for subsequent analysis, generation, evaluation, and addressing of plans, decision, and queries, or a combination thereof, based on the learned parameters 408A of the system, which is then outputted 410. The learned parameters 408A, as discussed in FIG. 1, determine the AI system's 408 knowledge and how it processes information. In some embodiments, the user may provide feedback 412 to the AI system 408 to improve it. There are many ways this may be accomplished; it may be indirect, through a separate pipeline (not shown) where a manual or automated system, through supervised or unsupervised training, can receive and add the feedback to the database (not shown) to train a future version of the AI system 408. Alternatively, feedback may be direct through, for example, an active learning system. In this method, the user provides feedback directly to the AI system 408 as it would any other input 402, learning from the feedback and incorporating it into its learned parameters 408A. In such a case, the output 410 of the AI System 408 would likely be an acknowledgement of receiving the feedback. Note that the user may not necessarily be a human, but may be another entity such as a distinct AI system (not shown) or the very same AI system 408 itself.

The AI system 408 analyzes, generates, evaluates, and addresses plans, decisions, and queries-or a combination thereof-by considering the request in the context of its extensive knowledge base and current situational data. This process may involve, but is not limit to, multiple stages: 1. Context Understanding: The system uses natural language processing and knowledge graph techniques to fully understand the context and implications of the input. 2. Relevant Knowledge Retrieval: It queries its knowledge base, which may include military doctrines, historical data, and real-time intelligence, to retrieve relevant information. 3. Reasoning and Analysis: Using a combination of symbolic AI for logical reasoning and neural networks for pattern recognition and prediction, the system analyzes the situation and generates potential solutions or responses. 4. Evaluation and Ranking: The system evaluates generated options using predefined criteria and sophisticated simulation models, ranking them based on projected outcomes and alignment with strategic objectives. 5. Response Generation: Finally, it formulates a response, which could be a detailed plan, a decision recommendation, or an answer to a query, tailoring the format and level of detail to the user's needs and preferences.

In some embodiments, the AI system 408 may be able to directly receive inputs 402 and deliver outputs 410 in a format outside of text. It may be able to receive and deliver audio, video, images, documents, or any other format that can be used to transmit information. This multi-modal capability may be achieved through, but is not limited to, a series of specialized modules: 1. Audio Processing: Uses advanced speech recognition and natural language understanding models to interpret voice commands and generate spoken responses. 2. Image and Video Analysis: Employs state-of-the-art computer vision algorithms to extract relevant information from visual inputs and generate visual outputs such as annotated maps or simulated scenarios. 3. Document Processing: Utilizes natural language processing and optical character recognition to extract information from various document formats, and can generate formatted reports, orders, or other military documents. 4. Sensor Data Integration: Can process and interpret data from various military sensors, including radar, sonar, and electronic intelligence systems, integrating this information into its analysis and decision-making processes. 5. Augmented Reality Integration: Capable of generating outputs suitable for augmented reality displays, providing real-time, context-aware information overlays for field operations. This multi-modal capability allows the system to adapt to various operational environments and user preferences, enhancing its utility across different military scenarios and platforms.

FIG. 5 illustrates the multi-agent system architecture of ATHENA, demonstrating how specialized AI agents collaborate to address complex military scenarios. This architecture enables ATHENA to leverage domain-specific expertise while maintaining a holistic approach to military planning and decision support.

At the core of the multi-agent system is the Central Coordination Agent (CCA) 502. The CCA 502 serves as the primary interface between the user and the specialized agents, managing task allocation, information flow, and conflict resolution. When a query or task is input into the system, the CCA 502 analyzes it to determine which specialized agents are required and in what sequence they should be activated.

Surrounding the CCA 502 are various specialized agents, each focused on a specific domain of military operations. These may include, but are not limited to: an Intelligence Analysis Agent (IAA) 504, a Logistics Planning Agent (LPA) 506, a Tactical Operations Agent (TOA) 508, a Strategic Planning Agent (SPA) 510, a Cyber Operations Agent (COA) 512, an Electronic Warfare Agent (EWA) 514, a Medical Support Agent (MSA) 516, an Environmental Analysis Agent (EAA) 518.

Each specialized agent is equipped with deep domain knowledge, relevant algorithms, and data processing capabilities specific to its area of expertise. For instance, the Intelligence Analysis Agent 504 utilizes advanced natural language processing and pattern recognition algorithms to process vast amounts of intelligence data, while the Logistics Planning Agent 506 employs sophisticated optimization algorithms to manage supply chains and resource allocation.

When a task is received, the CCA 502 initiates a multi-step process: 1. Task Analysis: The CCA 502 analyzes the input to determine the scope and requirements of the task. 2. Agent Activation: Based on the analysis, the CCA 502 activates the relevant specialized agents. 3. Information Gathering: Activated agents collect and process relevant data from their respective domains. 4. Collaborative Analysis: Agents share their findings and collaborate to develop comprehensive solutions. 5. Conflict Resolution: The CCA 502 mediates any conflicts or inconsistencies between agent outputs. 6. Solution Synthesis: The CCA 502 integrates the outputs from various agents into a cohesive solution. 7. User Presentation: The final solution is presented to the user through the user interface.

Throughout this process, agents communicate via a standardized protocol, allowing for efficient information exchange and collaboration. This modular architecture enables ATHENA to be easily updated or expanded by adding new specialized agents or enhancing existing ones without disrupting the overall system.

The multi-agent architecture also incorporates a feedback loop, where the outcomes of implemented decisions are fed back into the system. This allows agents to learn from real-world results, continuously improving their performance and the accuracy of their recommendations.

By leveraging this multi-agent architecture, ATHENA can provide nuanced, comprehensive solutions that consider multiple facets of military operations simultaneously. This approach enables more robust and adaptable military planning and decision support across a wide range of scenarios and operational contexts.

The multi-agent architecture of ATHENA also incorporates a Dynamic Learning Module (DLM) 520 that interfaces with all specialized agents (e.g., 504-518) and the CCA 502. The DLM 520 continuously analyzes the performance and outcomes of agent interactions, identifying patterns and insights that can improve overall system efficiency. This module enables ATHENA to adapt to new scenarios and evolving military doctrines in real-time, ensuring that the system remains current and effective.

Security and ethical considerations are embedded throughout the multi-agent architecture. Each agent, including the CCA 502, incorporates a Security and Ethics Verification (SEV) 522 sub-module. These SEV 522 sub-modules work in concert to ensure that all recommendations and actions proposed by ATHENA adhere to established security protocols and ethical guidelines. This distributed approach to security and ethics provides multiple layers of safeguards throughout the decision-making process.

The architecture also features a Scenario Simulation Engine (SSE) (not shown) that interacts with all specialized agents (e.g., 504-518). The SSE (not shown) allows ATHENA to run complex, multi-domain simulations by leveraging the expertise of various agents. This capability enables the system to test and refine potential courses of action in a virtual environment before presenting recommendations to users, significantly enhancing the robustness and reliability of ATHENA's outputs.

### ADDITIONAL CONSIDERATIONS

The foregoing description provides a comprehensive overview of the artificial intelligence system's capabilities for military planning and decision support across various operational domains. Those skilled in the art will recognize that further modifications and enhancements are possible within the scope of the invention as defined by the appended claims. As military technologies and operational environments continue to evolve, so too can this system adapt to meet new challenges and requirements.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although the disclosure herein sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Various aspects and functions described herein may be implemented as specialized hardware or software components executing in one or more computer systems. There are many ways to implement the systems and methods disclosed herein. The described components may be implemented in hardware, software, or a combination thereof, all of which are within the scope of this disclosure.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof.

The components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user space application) or in a commonly shared data structure (such as an application registry that is defined by an operating system). In addition, some examples provide for both system and user interfaces that allow external entities to modify the parameters and thereby configure the behavior of the components.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location, while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other embodiments, the one or more processors or processor-implemented modules may be distributed across a number of geographic locations.

Based on the foregoing disclosure, it should be apparent to one of ordinary skill in the art that the embodiments disclosed herein are not limited to a particular computer system platform, processor, operating system, network, or communication protocol. Also, it should be apparent that the embodiments disclosed herein are not limited to a specific architecture or programming language.

This description of the exemplary embodiments is intended to be read in connection with the accompanying drawings, which are to be considered part of the entire written description. The terms and words used in the following description and claims are not limited to the bibliographical meanings, but, are merely used to enable a clear and consistent understanding of the invention.

This detailed description is to be construed as exemplary only and does not describe every possible embodiment, as describing every possible embodiment would be impractical, if not impossible. A person of ordinary skill in the art may implement numerous alternate embodiments, using either current technology or technology developed after the filing date of this application.

Those of ordinary skill in the art will recognize that a wide variety of modifications, alterations, and combinations can be made with respect to the above described embodiments without departing from the scope of the invention, and that such modifications, alterations, and combinations are to be viewed as being within the ambit of the inventive concept.

This detailed description is to be construed as exemplary only and does not describe every possible embodiment, as describing every possible embodiment would be impractical, if not impossible. One could implement numerous alternate embodiments, using either current technology or technology developed after the filing date of this application.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Certain inventive embodiments herein contemplate numerical ranges. When ranges are present, the ranges include the range endpoints. Additionally, every sub range and value within the range is present as if explicitly written out. The term “about” or “approximately” may mean within an acceptable error range for the particular value, which will depend in part on how the value is measured or determined, e.g., the limitations of the measurement system. For example, “about” may mean within 1 or more than 1 standard deviation, per the practice in the art. Alternatively, “about” may mean a range of up to 20%, up to 10%, up to 5%, or up to 1% of a given value. Where particular values are described in the application and claims, unless otherwise stated the term “about” meaning within an acceptable error range for the particular value may be assumed.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed is:

1. An artificial intelligence system for military planning and decision support, comprising:
at least one artificial intelligence component configured to:
receive an input query or task;
analyze the input to determine at least one relevant military domain;
process domain-specific data relevant to the input using at least one of natural language processing, computer vision, machine learning, knowledge-based reasoning, or combinations thereof;
generate a solution for at least one military domain; and
present the solution to a user.

2. The system of claim 1, wherein the artificial intelligence component comprises at least one coordination component and at least one specialized component, each configured to process data related to at least one specific domain of military operations.

3. The system of claim 2, wherein the coordination component is configured to:
receive an input query or task;
analyze the input to determine relevant specialized components;
activate the relevant specialized components;
coordinate information exchange between activated components;
synthesize outputs from the activated components into a cohesive solution; and
present the solution to a user.

4. The system of claim 2, wherein the specialized components are configured to:
collect and process domain-specific data relevant to the input;
collaborate with other activated components to develop comprehensive solutions; and
provide domain-specific outputs to the coordination component.

5. The system of claim 1, wherein the system utilizes at least one of machine learning models, rule-based systems, statistical analysis techniques, or combinations thereof.

6. The system of claim 1, further comprising a dynamic learning module configured to:
continuously analyze performance and outcomes of component interactions;
identify patterns and insights to improve system efficiency; and
adapt the system to new scenarios and evolving military doctrines in real-time.

7. The system of claim 1, wherein the specialized components comprise one or more of:
an intelligence analysis agent;
a logistics planning agent;
a tactical operations agent;
a strategic planning agent;
a cyber operations agent;
an electronic warfare agent;
a medical support agent; and
an environmental analysis agent.

8. The system of claim 1, further comprising a security and ethics verification module configured to ensure adherence to security protocols and ethical guidelines.

9. The system of claim 1, further comprising one or more additional sub-modules configured to enhance system functionality, wherein the one or more additional sub-modules comprise at least one of:
a data validation sub-module;
a performance optimization sub-module;
a cross-domain integration sub-module;
a user preference learning sub-module; and
a resource allocation sub-module.

10. The system of claim 1, further comprising a scenario simulation engine configured to run complex, multi-domain simulations to test and refine potential courses of action.

11. The system of claim 1, wherein the system is configured to operate in both local and remote configurations, comprising:
a streamlined version installable on mobile devices for local operation; and
a full version accessible via remote servers when network connectivity is available.

12. The system of claim 1, wherein the system incorporates advanced natural language processing capabilities enabling multi-lingual operation, including:
real-time translation between numerous languages;
generation of operation orders in multiple languages simultaneously;
rapid translation and analysis of foreign language communications; and
continuous updating of language models to account for regional dialects, slang, and emerging terminology.

13. The system of claim 1, wherein the system incorporates explainable artificial intelligence components configured to provide justifications for recommendations.

14. The system of claim 1, further comprising a multi-modal interface configured to:
process input in various formats including text, voice, images, and structured data; and
generate output in various formats including text, voice, images, and structured data.

15. The system of claim 1, wherein the system employs reinforcement learning algorithms to iteratively improve its planning and decision-making capabilities.

16. The system of claim 1, wherein the system utilizes at least one advanced search or optimization algorithm to efficiently explore decision spaces, said algorithm comprising at least one of:
(a) a Monte Carlo Tree Search (MCTS) algorithm;
(b) a neural network-enhanced search algorithm;
(c) a genetic algorithm;
(d) a simulated annealing algorithm;
(e) a reinforcement learning algorithm;
(f) a deep learning algorithm;
(g) a Bayesian optimization algorithm;
(h) a particle swarm optimization algorithm;
(i) a tabu search algorithm;
(j) an A* search algorithm;
(k) a minimax algorithm with alpha-beta pruning;
(l) a Monte Carlo sampling algorithm;
(m) a gradient-based optimization algorithm;
(n) an evolutionary strategy algorithm; or
(o) any combination or variation thereof;
wherein the algorithm may be further enhanced by one or more of:
(i) neural network heuristics;
(ii) machine learning techniques;
(iii) expert knowledge integration;
(iv) parallel processing;
(v) adaptive sampling strategies;
(vi) multi-objective optimization techniques; or
(vii) hierarchical search strategies.

17. The system of claim 1, wherein the system is configured to generate and evaluate multiple courses of action for a given tactical situation, considering factors including terrain, weather, force composition, and supply status.

18. The system of claim 1, wherein the system incorporates a continuous learning and feedback loop, allowing it to:
learn from real-world outcomes of implemented decisions;
continuously update its knowledge base with new tactical insights and doctrinal changes; and
adapt its planning and advisory capabilities as warfare evolves.

19. The system of claim 1, wherein the system is configured to automatically generate military documents including operations orders, intelligence summaries, and after-action reports.

20. The system of claim 1, wherein the system is capable of generating outputs suitable for augmented reality displays, providing real-time, context-aware information overlays for field operations.
